(19) United States
(12) Patent Application Publication
(10) Pub. No.: US 2011/0086174 A1
(43) Pub. Date: Apr. 14, 2011

(54) PAINT COMPOSITION INCLUDING NANO-CERAMIC AND POLYMER RESIN AGAINST NEUTRALIZATION AND SALT DAMAGE OF CONCRETE AND METHOD FOR WATERPROOF AND ANTICORROSION USING THE SAME

(75) Inventors: Sang Woo LEE, Chuncheon-si (KR); Yang Gu KIM, Wonju-si (KR); Tae Ju CHUNG, Wonju-si (KR); Chi Moon WON, Wonju-si (KR); Soo Jong KIM, Wonju-si (KR)

(73) Assignee: HAN TO INDUSTRY CO., LTD, Wonju-si (KR)

(21) Appl. No.: 12/901,667

(22) Filed: Oct. 11, 2010

(30) Foreign Application Priority Data
Oct. 12, 2009 (KR) 10-2009-0096696

(51) Int. Cl. C09D 5/08; B05D 1/36

(52) U.S. Cl. 427/407.1; 523/434

(57) ABSTRACT

The present invention relates to a polymer paint composition for waterproof and anticorrosion of concrete, which prevents neutralization and salt damage of concrete gradually degraded by external environment, by fundamentally blocking the material causing such damage, and a method for waterproof and anticorrosion of concrete structure using the same. In particular, the present invention relates to a paint polymer composition for preventing neutralization and salt damage of concrete structures in the atmosphere or under water, such as concrete structures in various marine environments, harbor structures, underground structures, exposed structures, structures neutralized by aging, bridge structures repeatedly exposed to wetness and dryness, structures exposed to chemical erosion by calcium chloride, SOx, NOx, etc. In more particular, the present invention relates to a polymer paint composition which has an excellent ability of preventing salt damage and neutralization, is capable of controlling hardening time in the air or under water, and has excellent adhesiveness with concrete structures.

### FIELD OF THE INVENTION

The present invention relates to a polymer paint composition for waterproof and anticorrosion of concrete, which prevents neutralization and salt damage of concrete gradually degraded by external environment, by fundamentally blocking the material causing such damage, and a method for waterproof and anticorrosion of concrete structure using the same. In particular, the present invention relates to a paint polymer composition for preventing neutralization and salt damage of concrete structures in the atmosphere or under water, such as concrete structures in various marine environments, harbor structures, underground structures, exposed structures, structures neutralized by aging, bridge structures repeatedly exposed to wetness and dryness, structures exposed to chemical erosion by calcium chloride, SOx, NOx, etc. In more particular, the present invention relates to a polymer paint composition which has an excellent ability of preventing salt damage and neutralization, is capable of controlling hardening time in the air or under water, and has excellent adhesiveness with concrete structures.

### DESCRIPTION OF THE RELATED ART

When cement, the main material of a concrete structure, is mixed with water at early stage, calcium hydroxide, a strong alkali of pH 12-13, is obtained, and accordingly the iron bars within the concrete structure do not rust easily because it is coated with an alkali coating. However, if a film of paint is not formed on the surface of the concrete structure, harmful compounds such as chlorides, etc. can easily adhere to the porous concrete surface. Concrete adhered with such harmful compounds can easily fall off by rain, wind, etc., and thus the harmful compounds can penetrate into the concrete structure more easily.

Also, chloride penetrates rapidly into vulnerable parts of the concrete structure such as construction joints where the concrete composition is not uniformly dispersed and a large amount of chloride is accumulated at such parts. Accordingly, concrete and structural steel (iron bar) start corrosion at early stage. Further, said chlorides attract a large amount of moisture and cause freezing trouble in the winter. Even when concrete does not have such defects, it is known that a great amount of the chloride adhered to the concrete surface gets inside the structure.

In addition, neutralization continues slowly by carbonation between carbon dioxide and concrete, acid rain, polluted air, CO₂, SO₂, salt damage, etc., causing concrete structures to be degraded, and finally shortening the lifetime of the concrete structure. Thus, it is known that it would be efficient to form a shield layer against harmful compounds for concrete structures at an earlier stage to prevent the corrosion of concrete and iron bars.

The paint used in concrete to form said shield layer must have saturation, waterproofness, alkali-resistance which are properties required for concrete, and good adhesiveness, abrasion resistance, weatherability, etc. as a film of paint. The paint applied to the concrete surface is also required to have properties of a film of paint such as water tightness, abrasion resistance and high hardness in addition to chemical resistance. This is because harmful compounds such as chlorides cannot easily adhere to the surface of the film of paint, and can get easily washed out by rain when paint having such properties is applied. In addition, the film of paint having the above properties has very low chloride ion penetrability, and thus chloride ion can hardly penetrate into the surface. Conventionally, as paint against salt damage of ordinary concrete structures (bridge, pier, tunnel, marine structure, purification plant, sewer system, etc.), various paints including ceramic-based paints, metal-based paints, epoxy-based paints, etc. were used. However, such paints had a lot of problems in durability (corrosion, neutralization, degrading, salt damage, freeze-thaw, etc.) against external environment, and it was impossible to apply such paints in damp environments and under water.

As paint against neutralization/salt damage of concrete structure generally used in Korea and foreign countries, paint mainly consisting of metal powder and an adhesive and ceramic-based paint for anticorrosion are mainly used.

The epoxy resin generally used as an adhesive is widely used as an adhesive and coating agent of structures for its excellent waterproofing quality, adhesiveness and chemical resistance. In this regard, bisphenol A-type, bisphenol F-type, trifunctional epoxy resin, tetrafunctional epoxy resin, novolak epoxy resin and plastic epoxy resin, etc. are resin most commonly used as the main component.

The conventional epoxy paint using the above epoxy resins as main component has excellent chemical resistance, adhesiveness and mechanical properties.

However, it has problems such that workability drops when ventilation is not good due to the organic solvent used for dispersing the epoxy resin, the paint has great danger of fire or explosion and pollutes the environment by discharging harmful organic solvents. A water-soluble epoxy paint has been studied to solve the above problems, but the properties of the film of paint fell shorter than the case of using an organic solvent, and thus the industry is greatly demanding for an environment-friendly epoxy paint.

### SUMMARY OF THE INVENTION

The present invention was devised to solve the above problems. It is an object of the present invention to provide a polymer paint composition for waterproof and anticorrosion of concrete, which has excellent basic properties as a paint such as chemical resistance and adhesiveness, and an elaborate structure, is capable of fundamentally blocking the penetration of chloride ion, SOx, NOx, sulphate included in the atmosphere, has excellent resistance against UV and water, and a good appearance, and is capable of providing an environment-friendly coating.

It is another object of the present invention to provide a method for waterproof and anticorrosion of concrete structure using the polymer paint composition for waterproof and anticorrosion of concrete.

In order to achieve the above described objects, the polymer paint composition for waterproof and anticorrosion of concrete of the present invention, comprises: (A) a main component consisting of: 100 parts by weight of bisphenol A-type epoxy resin; 20.3-37.6 parts by weight of acrylate resin; 7.4-13.7 parts by weight of epoxy reactive diluent; 9.2-17.1 parts by weight of silicon carbide (SiC); 9.2-17.1 parts by weight of alumina; 9.2-17.1 parts by weight of silica; 11.1-20.5 parts by weight of ZnO; 16.6-30.8 parts by weight of TiO₂; 12.9-23.9 parts by weight of CaCO₃; 14.7-27.4 parts by weight of inorganic pigment; 0.7-1.4 parts by weight of hydrophilic silica powder; 0.7-1.4 parts by weight of lipophilic clay powder; 0.2-0.3 parts by weight of epoxy-based silane coupling agent; 0.4-0.7 parts by weight of anti-foaming agent; 0.7-1.4 parts by weight of dispersing agent; 0.4-0.7 parts by weight of ultraviolet stabilizer; and 0.6-1.0 parts by weight of ultraviolet blocking agent; and (B) a hardener consisting of: 100 parts by weight of modified alicyclic amine; 15.0-27.9 parts by weight of non-yellowing polyisocyanate hardener; 16.3-30.2 parts by weight of silica; 20.0-37.1 parts by weight of CaCO₃; 1.3-2.3 parts by weight of hydrophilic silica powder; 0.5-0.9 parts by weight of lipophilic clay powder; 0.8-1.4 parts by weight of anti-foaming agent; and 1.3-2.3 parts by weight of dispersing agent; characterized in that the weight ratio between the main component and the hardener is 1:1-5:1, preferably, 1:1-4:1, more preferably, 1:1-3:1.

Preferably, the epoxy equivalent weight of the bisphenol A-type epoxy resin is 180-195 g/eq.

Preferably, the viscosity of the bisphenol A-type epoxy resin is 11,000-14,000 cps at 25° C.

Preferably, the epoxy equivalent weight of the epoxy reactive diluent is 250-400 g/eq.

Preferably, the mean particle diameter of the silicon carbide is 300-500 nm

Preferably, the alumina is easily sinterable.

Preferably, the mean particle diameter of the alumina is 500-1,000 nm.

Preferably, the mean particle diameter of ZnO is 500-1,000 nm.

Preferably, the mean particle diameter of TiO₂ is 100-300 nm.

Preferably, the mean particle diameter of CaCO₃ comprising the main component is 500-1,000 nm.

Preferably, the inorganic pigment comprising the main component is Fe₂O₃.

Preferably, the mean particle diameter of the hydrophilic silica powder is 5-10 nm.

Preferably, the specific surface area (BET) of the hydrophilic silica powder is 250-350 m²/g.

Preferably, the mean particle diameter of the lipophilic clay powder is 1-5 μm.

Preferably, the bulk density of the lipophilic clay powder is 250-500 g/l.

Preferably, the amine equivalent weight of the modified alicyclic amine is 200-350 mgKOH/g.

Preferably, the gelling time of the modified alicyclic amine is 30 minutes-1 hour.

Preferably, the viscosity of the non-yellowing polyisocyanate hardener is 230-450 cps.

Preferably, the mean particle diameter of the silica is 700-1,500 nm

Preferably, the mean particle diameter of CaCO₃ comprising the hardener is 300-500 nm.

Meanwhile, the method for waterproof and anticorrosion of concrete of the present invention comprises the steps of: coating a penetrating epoxy primer on the concrete surface; and coating the polymer paint composition for waterproof and anticorrosion of concrete on the epoxy primer in a thickness of 1-10 mm for 1-5 times after the epoxy primer penetrates into the concrete surface.

### DETAILED DESCRIPTION OF THE PREFERRED EMBODIMENTS

The polymer paint composition for waterproof and anticorrosion of concrete of the present invention has excellent adhesiveness with existing concrete structures, and excellent strength. Also, it is an environment-friendly paint composition which does not use a thinner or an organic solvent, and thus does not present any substances harmful to human beings at the contact surface with water. In addition, the paint composition of the present invention hardly has any damage caused by freeze-thaw, and thus has greatly improved the durability of concrete. Also, it has excellent anticorrosion (sulfate, carbonate, etc.) and chemical resistance (sulfuric acid, hydrochloric acid, nitric acid, calcium chloride, etc.) in environments damaged by salt and highly corroded environments. Further, it has excellent UV blocking ability, thus causing less color change and curls, and it is convenient to build, stable in quality and economic in maintenance, etc.

Also, the polymer paint composition of the present invention can prevent degrading of concrete which occurs when concrete gets neutralized by contacting with exhaust gas (sulphur dioxide, nitrogen dioxide gas, etc.) or carbonate gas and calcium hydroxide, and can prevent salt damage of the concrete itself caused when exposed to salt damage and corrosion of inner iron bars. Thus, using the properties to protect concrete as described above, the present technology can be applied to all kinds of iron bar concrete structures such as downtown structures exposed to relatively high concentration of carbon dioxide, waterfront structures exposed to salt damage, underground structures exposed to bad conditions, and thus can be widely used.

Hereinafter, preferred embodiments of the present invention will be described in detail. The following description will include explanation on detailed matters such as specific constitutional elements, but such matters are provided only to help understand the present invention, and a person having ordinary skill in the art can carry out the present invention without said details. Also, when explaining the present invention, if it is determined that detailed explanation on relevant well known function or constitution would make the gist of the present invention unclear, such explanation will be omitted.

The present invention relates to a method for waterproof and anticorrosion for protecting concrete surface by coating the polymer paint composition on it, which first aims at strengthening the concrete surface of concrete structures against penetration and presenting waterproofness and anticorrosion to concrete structures, and secondly aims at maintaining the appearance of the structure and improving durability by protecting the concrete structure from salt damage and neutralization by protecting the surface of the structure and blocking external factors degrading concrete such as chloride, carbon dioxide, water, etc. with its excellent salt damage resistance, chemical resistance, heat resistance, abrasion resistance, neutralization resistance, UV blocking ability and stability.

First, as an epoxy resin comprising the main component of the present invention, bisphenol A-type epoxy resin which may be considered to be a representative epoxy resin having an epoxy equivalent weight of 180-195 g/eq is used. By using an epoxy resin in the above range of equivalent weight, the desired properties of the film of paint can be obtained and the exterior of the film of paint can be prevented from being damaged. Also, the above object can be achieved and producibility can be guaranteed when the epoxy resin of the present invention has a viscosity in a range of 11,000-14,000 cps at 25° C. The bisphenol A-type epoxy resin which falls within such range of equivalent weight and viscosity can form a film of paint with excellent anticorrosion, water tightness, chemical resistance, etc. when being mixed with the following modified alicyclic amine hardener without using a thinner or an organic solvent.

The main component of the polymer paint composition of the present invention comprises an acrylate resin, an epoxy reactive diluent, and an epoxy-based silane coupling agent in addition to the bisphenol A-type epoxy resin so as to present the above properties of anticorrosion, water tightness, chemical resistance, etc, and have optimum function as a coupling agent. In particular, by containing an acrylate resin in addition to an epoxy resin, a film of paint with complex layers where an epoxy resin is placed on the concrete substrate and an acrylate resin is placed on the other side (external side) can be obtained during hardening. Preferably, the content of such acrylate resin is 20.3-37.6 parts by weight with respect to 100 parts by weight of the bisphenol A-type epoxy resin.

Also, in order to adjust the viscosity of the components of the main material and control reactivity, an epoxy reactive diluent such as BGE (butyl glycidyl ether), PGE (phenyl glycidyl ether), aliphatic glycidyl ether (C12-C14) having an epoxy equivalent weight of 135-330 g/eq is used. Preferably, the polymer paint composition of the present invention comprises 7.4-13.7 parts by weight of such epoxy reactive diluent with respect to 100 parts by weight of the bisphenol A-type epoxy resin. If the content is less than 7.4 parts by weight, the diluting effect drops, and thus it becomes impossible to stir the composition, and if the content exceeds 13.7 parts by weight, the viscosity of the main component decreases excessively, and thus interferes the reaction between the main component and the hardener. Preferably, the epoxy equivalent weight of the epoxy reactive diluent is 250-400 g/eq.

The polymer paint composition of the present invention contains a great amount of nano-ceramic particles. In particular, it comprises silicone carbide, alumina, silica, ZnO, TiO₂, and CaCO₃. Preferably, the mean particle diameter of these ceramic particles is in a nano range. In particular, the mean particle diameter of the silicon carbide is in a range of 300-500 nm, the mean particle diameter of the alumina is in a range of 500-1,000 nm, the mean particle diameter of the silica is in a range of 700-1,500 nm, the mean particle diameter of the ZnO is in a range of 500-1,000 nm, the mean particle diameter of the TiO₂ is in a range of 100-300 nm, and the mean particle diameter of the CaCO₃ is in a range of 500-1,000 nm.

Among the above components, silicon carbide does not exist as a natural mineral, and thus shall be artificially synthesized. It has excellent chemical stability and anticorrosion at high temperature. Such silicon carbide and alumina ultrafine particle powder emerge to the surface of the film of paint while drying, and form an elaborate film of paint with high hardness. Accordingly, it can prevent the penetration of vapor and other gas and liquid, present excellent moisture resistance, durability, weatherability, impact resistance, chemical resistance, and allow the coating surface to reflect light, thus protecting the film of paint from ultraviolet rays. Also, a rise in temperature of the adhered material is prevented due to the excellent thermal stability of silicon carbide and alumina, and accordingly concrete contracts and expands less, and the resin is prevented from neutralization/salt damage, thus maintaining the durability of the paint for a long period of time. The polymer paint composition of the present invention contains 9.2-17.1 parts by weight of such silicone carbide powder with respect to 100 parts by weight of bisphenol A-type epoxy resin. If the content of silicon carbide is less than 9.2 parts, the composition cannot exert chemical resistance and its overall properties, and if the content exceeds 17.1 parts by weight, workability drops due to the increase of viscosity and the hardness of the film of paint increases excessively, thus causing brittle failure.

The main component of the present invention further comprises alumina, which has high hardness and excellent strength and anticorrosion. Preferably, the alumina is easily sinterable. Also, preferably, the main component comprises 9.2-17.1 parts by weight of alumina with respect to 100 parts by weight of the bisphenol A-type epoxy resin. If the content is less than 9.2 parts by weight, the composition cannot reflect ultraviolet rays or prevent corrosion, and if the content exceeds 17.1 parts by weight, workability drops due to the increase of viscosity and specific gravity.

As for the contents of other nano-ceramic particles, in order to exert the properties of the paint of the present invention, preferably, the composition comprises 9.2-17.1 parts by weight of silica, 11.1-20.5 parts by weight of ZnO, 16.6-30.8 parts by weight of TiO₂, and 12.9-23.9 parts by weight of CaCO₃ with respect to 100 parts by weight of the bisphenol A-type epoxy resin. If the contents of ZnO and TiO₂ are less than the above ranges, the composition cannot be expected to have the effects of blocking and reflecting ultraviolet rays and purifying contaminants, and if the contents exceed the above ranges, the film of paint would reflect light excessively, and thus the composition cannot be used for structures requiring safety such as roads, etc.

As pigments comprising the main component of the present invention, inorganic pigments are used, and among inorganic pigments, preferably, Fe₂O₃ is used. It is preferable to add 14.7-27.4 parts by weight of inorganic pigment with respect to 100 parts by weight of bisphenol A-type epoxy resin comprising the main component. If the content is less than 14.7 parts by weight, the composition does not express vivid colors, and if the content exceeds 27.4 parts by weight, it takes too much time for the film of paint to be hardened, and thus may badly affect the properties by remarkably dropping its economics and roughening the surface roughness, etc.

Meanwhile, one of the most characteristic features of the present invention is that an anti-sagging agent in ceramic powder phase is used to improve its environment-friendly property. Preferably, the anti-sagging agent in ceramic powder phase comprising the main component of the present invention is a mixture of hydrophilic silica powder and lipophilic clay powder.

Preferably, to achieve the object of the present invention, the hydrophilic silica powder has a mean particle diameter in a range of 5-10 nm, and a specific surface area (BET) in a range of 250-350 m²/g.

Also, preferably, the lipophilic clay powder has a mean particle diameter in a range of 1-5 μm, and a bulk density in a range of 250-500 g/l.

The flow and rheological properties of the film of paint can be improved when the composition comprises 0.7-1.4 parts by weight of the hydrophilic silica powder and lipophilic clay powder with respect to 100 parts by weight of bisphenol A-type epoxy resin which constitutes the main component of the present invention. Thus, such contents are preferable for expressing the strength, hardness and surface roughness of the film of paint. If the contents are less than 0.7 parts by weight, such effect cannot be expected, and if the contents exceed 1.4 parts by weight, it badly affects the surface roughness and workability of the film of paint. If the content exceeds the range excessively, it may not even form a film of paint and remain in the form of paste.

By comprising the nano-ceramic particles and anti-sagging agent in ceramic powder phase described above, the polymer paint composition of the present invention can be in a paste state suitable for repairing the profile of a concrete structure greatly damaged.

Also, an epoxy-based silane compound (3-glycidoxypropyltrimethoxysilane) having a molecular weight in a range of 220-250 is used as a coupling agent used for improving the adhesiveness between the paint and adhered material. In addition, an amino-based silane (3-aminopropyltriethoxysilane), an acryl-based silane (3-methacryloxypropyltrimethoxysilane), a mercapto-based silane (3-mercaptopropyltrimethoxysilane), etc. can be used. The polymer paint composition of the present invention comprises 0.2-0.3 parts by weight of such silane compounds with respect to 100 parts by weight of the bisphenol A-type epoxy resin. The above content of the silane compound is the most suitable content generally used in the pertinent art for increasing adhesiveness between materials of different properties. If the content is less than 0.2 parts by weight or exceeds 0.3 parts by weight, the effect of improving adhesiveness cannot be expected.

It is preferable to use an anti-foaming agent to remove the foam generated while preparing the main component in the present invention. It is preferable to add 0.4-0.7 parts by weight of the anti-foaming agent with respect to 100 parts by weight of the bisphenol A-type epoxy resin. If the content is less than 0.4 parts by weight, no anti-foaming effect is presented, and if the content exceeds 0.7 parts by weight, the film of paint is degraded and blushing occurs.

Also, it is preferable to use a dispersing agent to uniformly disperse the components. It is more preferable to use a block copolymer solution of high molecular weight having a pigment affinity group in consideration of the bisphenol A-type epoxy resin and inorganic pigment comprising the main component in the present invention. It is preferable to add 0.7-1.4 parts by weight of the dispersing agent used in the main component of the present invention with respect to 100 parts by weight of bisphenol A-type epoxy resin. If the content deviates from the above range, pigment coheres, gloss deteriorates, defects occur in adhesiveness, solidity of the film of paint drops, and sulfuration occurs.

Preferably, the main component comprising the polymer paint composition of the present invention comprises 0.4-0.7 parts by weight of ultraviolet stabilizer and 0.6-1.0 parts by weight of ultraviolet blocking agent with respect to 100 parts by weight of the bisphenol A-type epoxy resin to improve the UV resistance of the film of paint. If the contents are less than the above ranges, it would be difficult to expect a sufficient ultraviolet blocking effect, and if the contents exceed the above ranges, the economics drop and physical properties of the film of paint are badly affected.

Meanwhile, it is preferable to use a modified alicyclic amine as a hardener used in the present invention in consideration of its reactivity with bisphenol A-type epoxy resin which constitutes the base of the film of paint. Preferably, the present invention comprises hardeners of the low-temperature hardening type capable of hardening not only in wet environment, but also under water.

In order for the above, preferably, the amine equivalent weight of the hardener is 200-350 mgKOH/g, and the gelling time is in a range of 30 minutes to 1 hour. In addition, preferably, the hardener has a viscosity of 230-450 cps. Accordingly, a film of paint which meets the conditions can be formed without using a thinner or an organic solvent. In particular, properties excellent for being applied to iron bar concrete can be guaranteed.

Meanwhile, preferably, the hardener of the present invention comprises 15.0-27.9 parts by weight of a non-yellowing polyisocyanate hardener with respect to 100 parts by weight of the modified alicyclic amine, in addition to the modified alicyclic amine to prevent yellowing together with hardening.

Preferably, the hardener used in the polymer paint composition for waterproof and anticorrosion of concrete of the present invention comprises nano-ceramic particles, particularly, silica and CaCO₃, as the main component described above. The function of these nano-ceramic particles is as explained regarding the main component. Preferably, the hardener comprises 16.3-30.2 parts by weight of silica, and 20.0-37.1 parts by weight of CaCO₃ with respect to 100 parts by weight of modified alicyclic amine.

The hardener of the present invention may comprise the anti-sagging agent of ceramic powder phase having the above-described ranges of mean particle diameter, specific surface area and bulk density. Preferably, the hardener comprises 1.3-2.3 parts by weight hydrophilic silica powder and 0.5-0.9 parts by weight of lipophilic clay powder with respect to 100 parts by weight of the modified alicyclic amine of the present invention. If the contents are less than the above ranges, the strength, hardness and surface roughness of the film of paint do not meet the conditions, and if the contents exceed the above ranges, it badly affects the surface roughness and workability of the film of paint.

In addition, preferably, the hardener of the present invention further comprises an anti-foaming agent the same as that added to the main component. It is preferable to add 0.8-1.4 parts by weight of the anti-foaming agent with respect to 100 parts by weight of the modified alicyclic amine. If the content is less than 0.8 parts by weight, no anti-foaming effect is presented, and if the content exceeds 1.4 parts by weight, the film of paint is degraded and blushing occurs.

Finally, preferably, the hardener of the present invention further comprises a dispersing agent the same as that added to the main component. It is preferable to add 1.3-2.3 parts by weight of the dispersing agent with respect to 100 parts by weight of modified alicyclic amine. If the content deviates from the above range, gloss deteriorates, defects occur in adhesiveness, solidity of the film of paint drops, and sulfuration occurs.

The mixture ratio of the main component and hardener of the present invention is 1:1-5:1 based on weight ratio, preferably 1:1-4:1, and more preferably 1:1-3:1. If the amount of hardener is less than that in a ratio of main component:hardener=5:1, the number of amine groups to react with epoxy groups will be absolutely short, and thus the composition cannot exert its efficacy as a paint, and if the amount of hardener exceeds that in a ratio of 1:1, the hardener reacts with the main component drastically, or deteriorates the property by having excessive non-reacting amine compound left in the composition.

The paint composition for waterproof and anticorrosion of concrete of the present invention starts to harden within 30 minutes from when the main component and hardener are mixed with each other in the atmosphere or under water, and is completely hardened generally within two hours. Thus, the composition is prepared to have a form of a two-liquid type composition using a mixture of the main component and the hardener.

After mixing bisphenol A-type epoxy resin with a small amount of dispersing agent at low speed, all other components except the anti-foaming agent and the anti-sagging agent are added and sufficiently dispersed at high speed. Then, anti-sagging agents such as hydrophilic silica powder and lipophilic clay powder are added little by little and mixed at high speed of at least 4,000 rpm for at least 30 minutes. Finally, after removing the foam inside the paint composition for waterproof and anticorrosion by adding a small amount of the anti-foaming agent to the mixture and stirring it at low speed, pressure is reduced within the pressure reducing vessel and the mixture is completely defoamed, thus completing the main component.

The hardener is prepared by the same method as the method for preparing the main component.

The polymer paint composition of the present invention prepared as above is coated on the concrete surface to prevent corrosion of concrete. A mixed layer of ceramics such as silicone carbide, alumina, silica, etc. is formed on the surface of the concrete structure and uniformly dispersed on the binder of the two-layered polymer component (epoxy and acryl). Also, durability can be remarkably increased without a separate top coating through the UV blocking component (radical scavenger, phenolic liquid type) emerging on the upper surface of the film, and an elaborate film of paint layer can be formed together with the ceramic component, to fundamentally block the chloride and chemical components penetrated from outside.

In addition, the polymer paint composition of the present invention is a paint blending acrylate and non-yellowing polyisocyanate hardener together with epoxy and modified alicyclic amine, which forms a two-layered complex film of paint layer having the epoxy resin mainly present on the adhesive surface of the concrete surface and the acrylate resin emerge above during hardening only by single coating. Accordingly, the disadvantages of the epoxy resin of easily turning yellow and going through photolysis when exposed to UV can be completely overcome by the acrylate resin layer combined with the UV blocking component. Thus, the lifetime of the film of paint can be remarkably increased by improving the capability of blocking harmful compounds including blocking ultraviolet, purifying contaminants, and preventing neutralization and salt damage. Thus, because its adhesiveness and durability, water resistance and moisture resistance, chemical resistance and heat resistance, impact resistance and crack following property, weatherability, etc. are remarkably superior to those of other paint, a film of paint completely protecting the adhered concrete is formed, and the durability of painting can be maintained for a long period of time even under harsh natural or artificial conditions.

Hereinafter, the method for coating the polymer paint composition of the present invention on concrete structure will be explained. When an ordinary penetrating primer is coated on the concrete surface with an airless spray of high pressure of at least 2,100 psi, due to the pressure, first the penetrating primer permeates into the concrete substrate, and it additionally penetrates into the concrete structure due to the capillary phenomenon thereafter, to form a waterproof and anticorrosion layer integrated with concrete at a total depth of 2.0-5.0 mm. This waterproof and anticorrosion layer prevents cracks from generating in the concrete itself and presents an effect of strengthening the surface. Then, by simply coating the polymer paint composition of the present invention once or twice in a thickness of 100-300 μm using a spray or brush or roller, a waterproof and anticorrosion layer durable for at least 10 years is formed. As for structures for worse conditions which require ultra durability, a top coating agent with remarkably improved UV blocking ability is further coated.

Hereinafter, examples of the present application will be described.

### EXAMPLES

### Example

### Polymer Paint Composition for Waterproof and Anticorrosion of Concrete

A composition is prepared by mixing components in contents shown in Table 1.

TABLE 1

| Component | | Content (g) |
|---|---|---|
| Main | Bisphenol A-type epoxy resin | 38 |
| component | (Kukdo Chemical YD-128) | |
| | Acrylate resin | 11 |
| | (Aekyung Chemical AA-969X) | |
| | Epoxy reactive diluent | 4 |
| | (Kukdo Chemical PG-207) | |
| | Silicon carbide (SiC) (300-500 nm) | 5 |
| | Easily sinterable alumina (Al₂O₃) | 5 |
| | (500-1,000 nm) | |
| | Silica (SiO₂) (700-1,500 nm) | 5 |
| | ZnO (500-1,000 nm) | 6 |
| | TiO₂ (100-300 nm) | 9 |
| | CaCO₃ (500-1,000 nm) | 7 |
| | Inorganic pigment (Fe₂O₃) | 8 |
| | Aerosil (Degussa Aerosil 300) | 0.4 |
| | Tixogel (RockwoodAdditives MP-250) | 0.4 |
| | Epoxy-based silane coupling agent | 0.1 |
| | Anti-foaming agent | 0.2 |
| | (BYK-Chemie BYK-A501) | |
| | Dispersing agent (BYK-Chemie BYK-#161) | 0.4 |
| | UV stabilizer (Ciba HALS Tinuvin 5100) | 0.2 |
| | UV blocking agent (Ciba phenolic ua-1000 d) | 0.3 |
| Total | | 100 |
| Hardener | Cycloaliphatic polyamine | 28 |
| | (Kukdo Chemical KH-816) | |
| | Non-yellowing polyisocyanate hardener | 6 |
| | (Aekyung Chemical DN-950) | |
| | Silica (SiO₂) powder (700-1,500 nm) | 6.5 |
| | CaCO₃ (300-500 nm) | 8 |
| | Tixogel (RockwoodAdditives MP-250) | 0.5 |
| | Anti-foaming agent (BYK-Chemie BYK-A501) | 0.2 |
| | Dispersing agent (BYK-Chemie BYK-#161) | 0.3 |
| | Aerosil (Degussa Aerosil #300) | 0.5 |

| | |
|---|---|
| Total | 50 |

### Experimental Examples

### Measuring Properties

After mixing the main component and hardener of the polymer paint composition for waterproof and anticorrosion of concrete consisted in the form of two-liquid type composition prepared in the above example, spray coating it on a concrete sample, and hardening it, the test results are shown in Table 2.

TABLE 2

| Test item | Unit | Result | Test method |
|---|---|---|---|
| Mixture ratio (main | weight ratio | 2:1 | |
| component/hardener) | | | |
| Curing time | hour | 1 | |
| Complete hardening time | hour | 8 | |
| Adhesiveness strength | N/mm² | 2.1 | KS F 4936 |
| Crack responsiveness | | OK | |
| (±20° C., after | | | |
| weatherability promoting | | | |
| test) | | | |
| Measuring depth of | mm | 0.1 | |
| neutralization | | | |
| Moisture permeability | g/m² · day | 2.6 | |
| Appearance after | | OK | KS F 4715 |
| forming film of paint | | | |
| Elasticity | | OK | KS M 5307 |
| Impact resistance | | OK | |
| Permeability resistance | | OK | |
| Chloride ion penetration | Coulombs | 219 | KS F 2711 |
| resistance | | | |
| Chlorine spraying test | | OK | KS D 9504 |
| Freeze-thaw resistance | % | 100 | KS F 2456 |
| (weight change) | | (400 cycles) | |
| Acid resistance | | OK | KS M ISO |
| (immersed for at least 168 | | | 2812-1-′03 |
| hr in 5% hydrochloric | | | |
| acid and 5% sulfuric acid) | | | |
| Alkali resistance | | OK | |
| (immersed for at least 168 | | | |
| hr in 4% calcium | | | |
| chloride) | | | |
| Detection of harmful | mg/L | Not | Ministry of |
| materials | | detected | Environment |
| (Pb, Cd, Cr⁺⁶, Cu, As, Hg, | | | Notification |
| CN⁻, organic phosphorus, | | | No. 2004-185; |
| trichloroethylene, | | | Waste |
| tetrachloroethylene) | | | processing test |

The polymer paint composition of the present invention presenting excellent effects as described above is compared with the conventional painting material as shown in the following tables 3 & 4.

TABLE 3

| | | | | | | Rubber | |
|---|---|---|---|---|---|---|---|
| | | Epoxy-based | Acryl-based | Urethane- | Polyurea-based | asphalt-based | |
| | | painting | painting | based painting | painting | painting | |
| | | material | material | material | material | material | Examples |
| Summary | | Two-liquid | One-liquid | Two-liquid | Two-liquid | One-liquid | Prepared by a |
| | | type | type | type | type | type | nontoxic |
| | | composition | composition in | composition | composition | composition in | environment- |
| | | comprising a | emulsion state | forming an | forming a | emulsion state | friendly method |
| | | main | comprising | elastic | waterproof layer | emulsifying | by penetrating |
| | | component | acrylate as | waterproof | by heating, | and dispersing | main |
| | | having | main material, | layer by | mixing, | asphalt and | component |
| | | bisphenol | forming a | combining | spraying | natural/ | consisting of |
| | | group and an | waterproof | alcohol group | isocyanate | synthetic | nano-ceramic |
| | | amine | layer by | with | prepolymer and | rubber in | particles and |
| | | hardener, | evaporation of | isocyanate | polyamine at | water, | polymer resin |
| | | forming a | moisture | group | high pressure | forming an | and adhering |
| | | waterproof | | | | elastic | the coating |
| | | layer of high | | | | waterproof | |
| | | strength | | | | layer | |
| Method | | smoothening | smoothening | smoothening | smoothening | smoothening | smoothening |
| | | surface | surface | surface | surface | surface | surface |
| | | coating | adhering | coating | coating primer | coating | coating |
| | | primer | reinforcing | primer | coating | primer | penetrating |
| | | coating | fabric | coating | waterproof | adhering | primer |
| | | waterproof | coating | waterproof | material (2-3 | reinforcing | coating |
| | | material (0.1-1 | waterproof | material (3-5 | mm) | fabric | waterproof |
| | | mm) | material (1-2 | mm) | applying top | coating | material (0.1- |
| | | applying top | mm) | applying top | coating | waterproof | 0.3 mm) |
| | | coating | | coating | | material | |
| | | | | | | (3mm) | |
| | | | | | | applying | |
| | | | | | | finishing | |
| | | | | | | coating | |
| Advantage | | Excellent | excellent | excellent | excellent | excellent | excellent |
| | | adhesiveness | weatherability | adhesiveness | adhesiveness | adhesiveness | adhesiveness, |
| | | high strength, | (heat | excellent | excellent | excellent | crack |
| | | high hardness, | resistance, cold | elasticity, | flexibility, crack | elasticity, | resistance, |
| | | excellent | resistance), | flexibility, | resistance, heat | crack | abrasion |
| | | abrasion | ozone | tensile, tear | stability (cold | resistance | resistance |
| | | resistance | resistance, | strength, crack | resistance) | excellent | excellent |
| | | excellent | alkali | resistance, | excellent | cold | durability |
| | | chemical | resistance, oil | durability | abrasion | resistance, | against |
| | | resistance | resistance | excellent | resistance | heat | neutralization, |
| | | forms a good | easy to build | water | good chemical | resistance | degrading, salt |
| | | appearance | low cost | resistance, | resistance | one-time | damage, freeze- |
| | | with high gloss | | chemical | rapid | coating is | thaw, etc. |
| | | and various | | resistance | construction | thick, and | excellent |
| | | colors | | one-time | (hardening takes | capable of | chemical |
| | | | | coating is | 3 minutes), | constructing | resistance such |
| | | | | thick, and has | labor cost saved | steep incline, | as acid |
| | | | | good | can be | curved | resistance, |
| | | | | workability | constructed in | surface, | alkali |
| | | | | occupies | all seasons | interior or | resistance, oil |
| | | | | largest portion | 100% solid | exterior walls, | resistance, etc. |
| | | | | in the Korean | powder, non- | etc. | excellent |
| | | | | market | solvent type, | non-solvent | water resistance |
| | | | | | and thus | type, and thus | forms a good |
| | | | | | environment- | environment- | appearance with |
| | | | | | friendly | friendly | high gloss and |
| | | | | | | | various colors |
| Disadvantage | | low flexibility | not suitable | low | requires an | requires | cannot be used |
| | | and elasticity, | for places | hardness, and | expensive | exclusive | at a temperature |
| | | thus having | where moisture | thus weak to | exclusive | cement spray | of 5° C. or below |
| | | weak crack | cannot easily | scratches | cement spray | apparatus | mixture ratio |
| | | resistance, and | evaporate | weak | apparatus (high | difficult to | between main |
| | | construction | (indoor | against heat | temperature, | adjust colors | component and |
| | | joints break | waterproof) | and ultraviolet | high pressure | and | hardener and |
| | | easily | weak water | rays, | spray) | appearance | hardening |
| | | weak against | resistance, acid | deteriorating | weak to salt | deteriorates | method must be |
| | | heat and | resistance, | durability | resistance, water | difficult to | strictly |
| | | ultraviolet rays, | chemical | reacted with | resistance | construct, and | followed |
| | | causing | resistance | water, and | hardens fast, | thus requires | |
| | | yellowing and | low hardness, | thus requires | and thus defects | high labor cost | |
| | | choking, and | and thus weak | complete | occur frequently | when | |
| | | deteriorating | to scratches, | drying of the | in pin holes, and | compared with | |
| | | durability | and easily | construction | cannot be | material cost | |
| | | mixture ratio | contaminated | surface | worked by hand | hardly has | |
| | | between main | | when | requires expert | any | |
| | | component and | | atmosphere | mechanics | construction | |
| | | hardener and | | temperature | easily turns | work in Korea. | |
| | | hardening | | rises, curls | into gel by | | |
| | | method must | | generate due | reacting with | | |
| | | be strictly | | to heat | moisture, and | | |
| | | followed | | expansion | thus should be | | |
| | | | | flow in | carefully stored | | |
| | | | | vertical | | | |
| | | | | surface | | | |
| | | | | solvent type | | | |
| Durability | | 2-3 years | 2-3 years | 3-5 years | 3-5 years | 3-5 years | 10 years |
| Economic | Beginning | 16,200 won/m² | 11,400 won/m² | 24,000 won/m² | 26,500 won/m² | 25,300 won/m² | 31,200 won/m² |
| feasibility | Demolition | 15,000 won/m² | 15,000 won/m² | 15,000 won/m² | 15,000 won/m² | 15,000 won/m² | — |
| | 10 years | 78,600 won/m² | 64,200 won/m² | 63,000 won/m² | 68,000 won/m² | 65,600 won/m² | 31,200 won/m² |

TABLE 4

| | | Pure ceramic-based | Ceramic metal-based | |
|---|---|---|---|---|
| | | painting material | painting material | Examples |
| Summary | | A water-soluble one-liquid | Two-liquid type paint using an | Prepared by a nontoxic |
| | | type paint consisting only of | organic solvent, comprising a | environment-friendly method |
| | | pure ceramic components | ceramic-metal agent and | by penetrating main component |
| | | comprises only fire resistant | coating agent | consisting of nano-ceramic |
| | | materials, and thus meets the | improving durability of | particles and polymer resin and |
| | | incombustible (non-flammable) | coated surface by blending | adhering the coating |
| | | properties but basic properties | various resins with ceramic | |
| | | of the paint is not good | | |
| Binder | | Ceramic-based binder such as | Epoxy or urethane | Modified epoxy or modified |
| | | potassium silicate | | acryl |
| Filler | | Pigment, other additives | Pigment, micro-ceramic, | Pigment, nano-ceramic, other |
| | | | micro-metal, other additives | additives |
| Solvent | | Water | Thinner | None |
| Method | | smoothening surface | smoothening surface | smoothening surface |
| | | coating primer | coating epoxy primer | coating penetrating primer |
| | | coating ceramic-based | coating epoxy ceramic-metal | coating composition in |
| | | composition | based composition | embodiment |
| | | | coating urethane ceramic- | top coating |
| | | | based top coating | |
| Advantage | | strong at high temperature | excellent initial adhesiveness | excellent adhesiveness, crack |
| | | excellent workability | excellent durability against | resistance, abrasion resistance |
| | | a water-soluble paint does not | neutralization, degrading, salt | excellent durability against |
| | | include a solvent, and thus is | damage, freeze-thaw, etc. | neutralization, degrading, salt |
| | | environment-friendly | excellent chemical resistance | damage, freeze-thaw, etc. |
| | | | such as acid resistance, alkali | excellent chemical resistance |
| | | | resistance, oil resistance, etc. | such as acid resistance, alkali |
| | | | strong film of paint and good | resistance, oil resistance, etc. |
| | | | appearance | excellent water resistance |
| | | | | good appearance presenting |
| | | | | high gloss and various colors |
| Disadvantage | | low flexibility and elasticity, | expensive construction cost | cannot be used at a |
| | | thus having weak crack | mixture ratio between main | temperature of 5° C. or below |
| | | resistance, and construction | component and hardener and | mixture ratio between main |
| | | joints break easily | hardening method must be | component and hardener and |
| | | low adhesiveness and water | strictly followed | hardening method must be |
| | | resistance | film of paint has no | strictly followed |
| | | weak salt damage resistance | flexibility | |
| | | and acid resistance | paint layers may be | |
| | | when film of paint is thick, | separated | |
| | | the paint is not properly | organic solvent is used, and | |
| | | hardened, cracks occur, and | thus dangerous to worker and | |
| | | performance deteriorates | contaminates environment | |
| | | requires guidance of the | | |
| | | constructor | | |
| Durability | | 3-5 years | 5-8 years | 15 years (top coating applied) |
| Economic | Beginning | 46,000 won/m² | 58,000 won/m² | 42,000 won/m² |
| feasibility | | | | (top coating applied) |
| | Demolition | 15,000 won/m² | 15,000 won/m² | — |
| | 10 years | 107,000 won/m² | 131,000 won/m² | 42,000 won/m² |
| | | | | (top coating applied) |

The problem of prior art is that each composition clearly has its own strikingly contradicting advantages and disadvantages with regard to properties required for a paint composition. That is, as for epoxy-based paint, it has excellent chemical resistance and adhesiveness, but it has disadvantages that it easily turns yellow and goes through photolysis when exposed to UV, has low crack following property, and thus cannot be used for outdoor exposed structures. Also, as for urethane, it gets torn easily and thus must be coated in a thick layer. In addition, the ordinary ceramic-based paint for anticorrosion or paint adding metal powder has the basic disadvantages of polymer resins (epoxy, urethane, acryl, etc.) used as a binder, and has limitations in its durability despite its high cost. In order to overcome such disadvantages, the main film of paint is protected using a top coating material of different materials, but since this gets peeled off easily, additional cost would incur for maintenance service after a certain period of time.

As can be seen in Table 2 above, although the paint composition for waterproof and anticorrosion of the present invention is environment-friendly for not using a thinner or an organic solvent, the composition has high strength, impact resistance, moisture resistance, oil resistance, chemical resistance, hardness which are required for concrete, and as a result it has an excellent anticorrosive property. In addition, the curing time can be controlled by adjusting the mixture ratio of the main component and hardener, and thus it has an advantage of great workability at the construction site.

Preferred embodiments of the present invention have been explained. However, the present invention is not limited to the above-specified examples and various modifications can be made without departing from the gist of the present invention by a person having ordinary skill in the art. Thus, the scope of the present invention shall not be limited to the above examples, and shall include not only the following claims but also equivalents thereto.

What is claimed is:

1. A polymer paint composition for waterproof and anticorrosion of concrete, comprising:
(A) a main component consisting of:
100 parts by weight of bisphenol A-type epoxy resin;
20.3-37.6 parts by weight of acrylate resin;
7.4-13.7 parts by weight of epoxy reactive diluent;
9.2-17.1 parts by weight of silicon carbide;
9.2-17.1 parts by weight of alumina;
9.2-17.1 parts by weight of silica;
11.1-20.5 parts by weight of ZnO;
16.6-30.8 parts by weight of TiO₂;
12.9-23.9 parts by weight of CaCO₃;
14.7-27.4 parts by weight of inorganic pigment;
0.7-1.4 parts by weight of hydrophilic silica powder;
0.7-1.4 parts by weight of lipophilic clay powder;
0.2-0.3 parts by weight of epoxy-based silane coupling agent;
0.4-0.7 parts by weight of anti-foaming agent;
0.7-1.4 parts by weight of dispersing agent;
0.4-0.7 parts by weight of ultraviolet stabilizer; and
0.6-1.0 parts by weight of ultraviolet blocking agent; and
(B) a hardener consisting of:
100 parts by weight of modified alicyclic amine;
15.0-27.9 parts by weight of non-yellowing polyisocyanate hardener;
16.3-30.2 parts by weight of silica;
20.0-37.1 parts by weight of CaCO₃;
1.3-2.3 parts by weight of hydrophilic silica powder;
0.5-0.9 parts by weight of lipophilic clay powder;
0.8-1.4 parts by weight of anti-foaming agent; and
1.3-2.3 parts by weight of dispersing agent;
characterized in that the weight ratio between the main component and the hardener is 1:1-5:1.

2. A method for waterproof and anticorrosion of concrete comprising the steps of:
coating a penetrating epoxy primer on the concrete surface; and
coating the polymer paint composition for waterproof and anticorrosion of concrete according to claim 1 on the epoxy primer in a thickness of 1-10 mm for 1-5 times after the epoxy primer penetrates into the concrete surface.
